(19) United States
(12) Patent Application Publication
(10) Pub. No.: US 2002/0045974 A1
(43) Pub. Date: Apr. 18, 2002

(54) Dual-band radio communications system for aeronautical data communications

(76) Inventors: Stephen Heppe, Purcellville, VA (US); Steven Friedman, Silver Spring, MD (US)

Correspondence Address: BLANK ROME COMISKY & MCCAULEY LLP, THE FARRAGUT BUILDING SUITE 1000, 900 17TH STREET NW, WASHINGTON, DC, 20006, US

(21) Appl. No.: 09/848,550

(22) Filed: May 4, 2001

Related U.S. Application Data
(60) Provisional application No. 60/203,914, filed on May 12, 2000.

(51) Int. Cl. G06F 7/00

(52) U.S. Cl. 701/3; 701/10

(57) ABSTRACT

The present invention uses a VDL Mode 4 RF network as the primary transmission path for data transmitted from aircraft to ground stations, and one or more separate non-VDL Mode 4 RF network(s) as the primary transmission path for data transmitted from ground stations to aircraft. The unique characteristics of each network provide for a cost-effective solution to the two-way aeronautical networking problem.

### REFERENCE TO RELATED APPLICATION

The present application claims the benefit of U.S. Provisional Application No. 60/203,914, filed May 12, 2000, whose disclosure is hereby incorporated by reference in its entirety into the present disclosure.

### FIELD OF THE INVENTION

The present invention is directed to the economical provision of data networking services to and from aircraft.

### BACKGROUND OF THE INVENTION

At present it is difficult and costly for airline passengers in commercial aircraft to access modem data communications networks. While a data call can sometimes be configured from a personal computer through an air/ground telephone, the data rate is low, link reliability is low, and line charges are high. Several commercial companies have recently announced plans to deliver higher-quality, higher-speed services at lower cost.

Airlines themselves have poor access to modem data communications networks, with current air/ground data networking for Airline Operational Control (AOC) handled via 2.4 kbps modems within the ACARS family of protocols. The ACARS air/ground environment is described in ARINC Specification 618. The capabilities of onboard equipment are defined in ARINC Characteristics 597, 724 and 724B. Other standards may also apply. ACARS uses a p-persistent carrier-sense multiple-access scheme for packet data communications. Upgrades to ACARS are planned, which will increase the burst data rate but leave the access scheme essentially unchanged.

The International Civil Aviation Organization (ICAO) has recently recommended the adoption of standards for a new VHF Data Link Mode 4 (VDL/4). VDL/4 operates at 19.2 kbps and uses a self-organizing time-division multiple-access scheme for packet data communications. Part of the channel management scheme for VDL/4 relies on aircraft position information. Another part relies on accurate time known to all participating stations. VDL/4 has the potential to support several user applications including automatic dependent surveillance—broadcast (ADS-B) and air/ground networking. The ICAO standard for VDL/4 specifies operation in the 108-137 MHz band.

The following issues among others must be considered in order to deliver high-reliability, high-data-rate and low-cost two-way data networking services to passengers, crew and equipment onboard aircraft:

1. Radio-frequency (RF) subnetworks, providing air/ground connectivity directly or via satellites and other media, must be capable of providing high-data-rate communications;

2. Many existing and planned commercial high-data-rate RF subnetworks assume stationary or slowly-moving user terminals, in contrast to aircraft which move rapidly.

3. AOC and other airline- or crew-related communications are typically supported in a separate frequency band from passenger communications;

4. Many user applications, such as passenger access to the Internet, will tend to be dominated by large quantities of “uplink” data delivered to the aircraft from the ground and relatively small quantities of “downlink” data delivered to the ground from the aircraft (although occasional large downlink file transfers may occur).

5. RF subnetwork services may involve location-dependent pricing mechanisms.

6. Certain RF subnetworks may be constrained to avoid airborne transmissions in certain geographic domains, e.g. regions surrounding radio astronomy observatories.

7. Efficient sharing of a common communications channel by multiple aircraft generally requires the use of a suitable multiple-access protocol, which may be a distributed protocol or a centrally-managed protocol whereas transmissions from one or several ground stations or spacecraft can be managed from a central location so that overlapping transmissions are avoided, and the consequential loss of data is minimized.

### SUMMARY OF THE INVENTION

The present invention uses an ICAO-standard or modified VDL/4 RF network as the primary transmission path for data transmitted from aircraft to ground stations, and one or more separate non-VDL/4 RF network(s) as the primary transmission path for data transmitted from ground stations to aircraft. The unique characteristics of each network provide for a cost-effective solution to the two-way aeronautical networking problem.

### BRIEF DESCRIPTION OF DRAWINGS

FIG. 1 illustrates a hybrid air/ground data network according to the present invention, comprising an ICAO-standard or modified VDL/4 RF network and one or more additional RF networks.

### DETAILED DESCRIPTION OF THE INVENTION

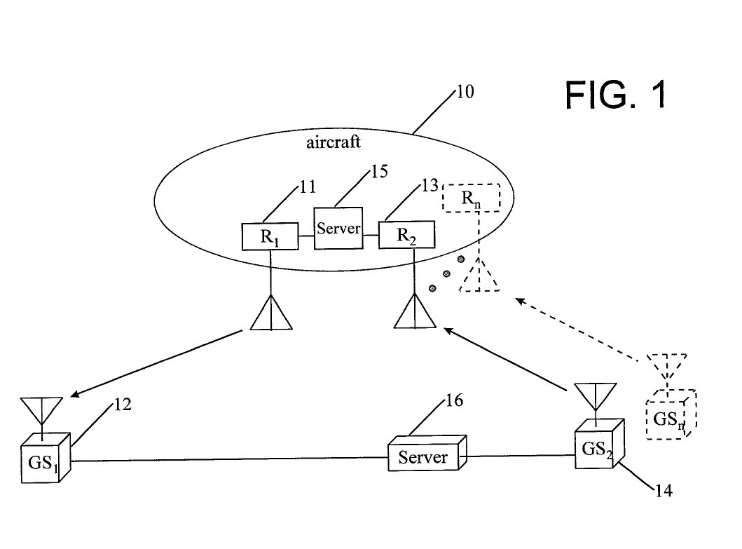

FIG. 1 illustrates a hybrid air/ground data network according to the present invention, comprising an ICAO-standard or modified VDL/4 RF network A and one or more additional RF networks B, C, etc. wherein the VDL/4 RF network A is the primary transmission path for data transmitted from aircraft to ground stations, and the separate one or more non-VDL/4 RF network(s) B, C, etc. is(are) the primary transmission path for data transmitted from ground stations to aircraft. The VDL/4 network A comprises an airborne radio R₁ 11 with associated antenna, ground station GS₁ 12 with associated antenna, and ground-based network control facilities (not shown). There may be several aircraft participating in one VDL/4 network, and there may be several ground stations. The other RF network B comprises an airborne radio R₂ 13 with associated antenna, ground station GS₂ 14 with associated antenna, and ground-based network control facilities (not shown). There may be several aircraft participating in RF network B, and there may be several ground stations associated with RF network B. If more than one other RF network is available, e.g. network C, D, etc. as illustrated in FIG. 1 by additional radios Rₙ and ground stations GSₙ, they may use different technologies and frequency bands from those used by the first other RF network B comprising radio R₂ 13 and GS₂ 14. For example, RF network B could be terrestrial UHF while an additional RF network C could be satellite-based. In general each RF network A, B, C, etc. provides two-way communications between aircraft and ground stations, however certain RF networks may be primarily or strictly limited to “forward link” communications only (i.e. transmissions to the aircraft).

An airborne server 15 and ground-based server 16 provide means to route data to/from desired applications and ground-based facilities (not shown) via the various available networks A, B, C, etc.

In a preferred embodiment of the present invention, the VDL/4 network is modified from the ICAO standard to operate in the UHF portion of the frequency band (300-3000 MHz) and at least one of the other RF networks B, C, D, etc. is a satellite-based wideband network providing “forward link” communications only. The modifications to the VDL/4 network, in order to operate efficiently in the UHF portion of the frequency spectrum, may involve changes in data rate, modulation index, coding, etc., but the media access protocols defined by the ICAO standard are entirely or substantially unchanged. In this preferred embodiment the modified VDL/4 network provides efficient access to one or several UHF frequency channels by a multiplicity of participating aircraft, allowing efficient return link data transfer (i.e., transmissions from an aircraft to the ground) as well as an optional path for forward link data transfer. Control traffic and network management data for the modified VDL/4 network are transmitted and received by aircraft and ground stations. Since the satellite-based wideband network B provides a primary path for forward link communications only, aircraft operate in receive-only mode (for network B) which reduces weight and complexity of airborne equipment, and the network B can be operated as a multiplexed broadcast channel with high throughput efficiency. This maximizes the utility and cost-effectiveness of the satellite-based network resources associated with network B. The aircraft position and velocity information, transferred as part of the network management and synchronization protocol of the modified VDL/4 network A, can be used to enhance the operation of the satellite-based network B (e.g. by allowing the selection of one of several spot beams, or doppler pre-compensation).

In a second embodiment of the present invention, the VDL/4 network operates in the VHF portion of the frequency spectrum according to the ICAO standard, communications data associated with safety and regularity of flight are carried with a high priority, and communications data for passenger correspondence are carried at a lower priority which avoids excessive time delay for higher-priority communications.

In a third embodiment of the present invention, a satellite-based network B provides two-way communications (forward link and return link) but the return link capability is intended primarily for use in areas where the ICAO standard or modified VDL/4 network A is not available (e.g., oceanic and remote areas). This embodiment requires aircraft to support transmit capability within the satellite-based network B, but provides enhanced or redundant coverage considering the two networks together and still allows the satellite-based network B to operate with a large fraction of its resources configured for forward-link communications.

While preferred embodiments of the present invention have been set forth above, those skilled in the art who have reviewed the present disclosure will readily appreciate that other embodiments can be realized within the scope of the invention. For example, protocols other than those disclosed can be used. Therefore, the present invention should be construed as limited only by the appended claims.

We claim:

1. A dual-band radio communications system for aeronautical data communications comprising:
avionics and ground systems supporting an ICAO standard or modified VDL Mode 4 network; and
avionics and ground systems supporting at least one other RF network;
wherein the ICAO standard or modified VDL Mode 4 network provides a primary return link path for user data and the at least one other RF network provides a primary forward link path for user data.

2. The dual-band radio communications system for aeronautical data communications of claim 1 wherein the VDL Mode 4 network is modified to operate in a portion of the RF spectrum other than the 108-137 MHz band.

3. The dual-band radio communications system for aeronautical data communications of claim 1 wherein at least one RF network is satellite-based.

4. The dual-band radio communications system for aeronautical data communications of claim 1 wherein one or more of the RF networks provide two-way communications capability for user communications.
